(19) United States
(12) Patent Application Publication
(10) Pub. No.: US 2007/0250684 A1
(43) Pub. Date: Oct. 25, 2007

(54) Central processing unit having a micro-code engine

(76) Inventors: Li-Fung Cheung, Huntingdon Beach, CA (US); Simon Law, Rancho Palos Verdes, CA (US); Ming-Chin Kang, Taoyuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/790,918

(22) Filed: Apr. 30, 2007

Related U.S. Application Data
(62) Division of application No. 10/875,829, filed on Jun. 24, 2004.
(60) Provisional application No. 60/549,620, filed on Mar. 2, 2004.

(51) Int. Cl. G06F 15/76

(52) U.S. Cl. 712/35

(57) ABSTRACT

A digital camera having a central processing unit with an embedded micro-code engine comprises a system memory capable of storing an instruction, at least one CPU execution unit electrically coupled with the system memory, and at least one micro-code engine electrically coupled with the CPU execution unit. The at least one CPU execution unit receive and decodes the instruction stored in the system memory. In response to the decoded instruction, the CPU execution unit sends commands and instruction parameters to at least one of an arithmetic logic unit of the CPU execution unit and the micro-code engine to execute the instruction. Typically the at least one CPU execution unit and the at least one micro-code engine operate in synchronization to execute the instruction.

### RELATED APPLICATIONS

This application is a Divisional patent application of co-pending application Ser. No. 10/875,829, filed on 24 Jun. 2004.

### BACKGROUND

Traditionally, in a device such as a digital camera, hardwired processors or software programs are used to execute instructions needed for image processing functions. While hardwire processors execute instructions quickly, they present a number of problems in the development of digital cameras. For example, once hardwired operations are fixed, the operations cannot be altered unless the hardwired processor is redesigned. In an area such as digital camera where designers must quickly create new instruction types to keep up with the current demand of customers for new and enhanced functionality, having to redesign the processor may increase development time and costs for a new digital camera. Additionally, if a problem is discovered in the design of a hardwired processor after the production of a digital camera, the problem cannot be fixed without replacing the hardwired processor in all of the digital cameras.

In an effort to provide flexibility, some digital camera use software programs to execute instructions. The flexibility of software comes at the price of speed due the time necessary to run the software program. Therefore, it is desirable to have a new processor for a device such as a digital camera that is able to execute instructions at an acceptable speed and provides flexibility to be able to add new instruction types to meet the current demands of customers.

### BRIEF SUMMARY

Accordingly, the present invention relates to using a central processing unit having a micro-code engine within a digital camera. In one embodiment, a central processing unit with an embedded micro-code engine comprises a system memory capable of storing an instruction; at least one central processing unit. (“CPU”) execution unit electrically coupled with the system memory to read the instruction stored in the system memory; and at least one micro-code engine electrically coupled with the at least one CPU execution unit to receive commands and instruction parameters. The at least one micro-code engine is operative to execute micro-code programs and operate in synchronization with the CPU execution unit to execute the instruction.

In another embodiment, a digital camera having a central processing unit with an embedded micro-code engine comprises a system memory capable of storing an instruction, at least one CPU execution unit electrically coupled with the system memory, and at least one micro-code engine electrically coupled with the CPU execution unit. The at least one CPU execution unit comprises an instruction decoder electrically coupled with the system memory to receive the instruction stored in the system memory and decode the instruction; a parameter fetching unit electrically coupled with the instruction decoder to receive instruction parameters; an arithmetic logic unit (“ALU”) execution unit electrically coupled with the parameter fetching unit to receive the instruction parameters and perform a logic operation; and a write back unit electrically coupled with the ALU execution unit to receive a result of the logic operation and electrically coupled with the system memory to write the result to said system memory. Through the electrical coupling with the CPU execution unit, the at least one micro-code engine is electrically coupled with the parameter fetching unit to receive commands and instruction parameters. The CPU execution unit and the at least one micro-code engine operate in synchronization to execute the instruction.

In yet another embodiment, a central processing unit comprises a fixed execution unit, a programmable execution unit, and a controller. The fixed execution unit is operative to perform a first plurality of functions and the programmable execution unit is operative to perform a second plurality of functions. The controller is electrically coupled with the fixed execution unit and the programmable execution unit. Typically, the controller receives an instruction from a memory. In response, the controller determines what functions are needed to perform the instruction from the first plurality of functions and the second plurality of functions. The controller generates a signal to at least one of the fixed execution unit and the programmable execution unit indicating the functions needed to perform the instruction.

The fixed execution unit comprises a first input coupled to the controller and operative to receive the signal, and a plurality of discrete logic elements coupled with the first input. Each of the plurality of discrete logic elements are interconnected with at least another of the plurality of discrete logic elements. In response to the signal, the fixed execution unit implements at least one of the first plurality of functions.

The programmable execution unit comprises a second input coupled to the controller and operative to receive the signal; a micro-code memory operative to store a plurality of micro-code programs, each of which is operative to implement at least one of the second plurality of functions; a micro-code execution unit coupled with the micro-code memory that is capable of executing each of the plurality of micro-code programs; and a micro-code controller coupled with the second input and the micro-code execution unit that is operative to cause the micro-code execution unit to execute at least one of the plurality of micro-code programs in response to the signal from the controller.

In another embodiment, a method for performing an instruction within a central processing unit comprises receiving an instruction from a memory coupled with a controller; determining a first function of at least one of a first plurality of functions capable of being performed by a fixed execution unit and a second plurality of functions capable of being performed by a programmable execution unit; generating a signal to at least one of said fixed execution unit and said programmable execution unit to perform said first function; determining in said fixed execution unit which, if any, of said first plurality of functions to execute in response to said signal; executing at least one of said first plurality of functions by a plurality of discrete logic elements to generate a first result in response to determining said fixed execution engine should execute at least one of said first plurality of functions; determining in said programmable execution unit which, if any, of said second plurality of functions to execute in response to said signal; and executing at least one micro-code program to implement at least one of said second plurality of functions to generate a second result in response to determining said programmable execution engine should execute at least one of said plurality of functions.

### DESCRIPTION OF THE DRAWINGS

FIG. 1 is a schematic diagram of one embodiment of a central processing unit having a micro-code engine;

FIG. 2 is a schematic diagram of a second embodiment of a central processing unit having a micro-code engine;

FIG. 3 is a schematic diagram of one embodiment of a micro-code engine having a linear shift register;

FIG. 4 is a diagram of a shift-able window over a set of targeted data;

FIG. 5 is a diagram showing one possible mapping of a linear shift register;

FIG. 6a is a diagram of one embodiment of a linear shift register before a shift operation;

FIG. 6b is a diagram of the linear shift register of FIG. 6a after a shift operation; and

FIG. 7 is a schematic diagram of a shift register micro-engine.

### DETAILED DESCRIPTION OF THE DRAWINGS AND THE PRESENTLY PREFERRED EMBODIMENTS

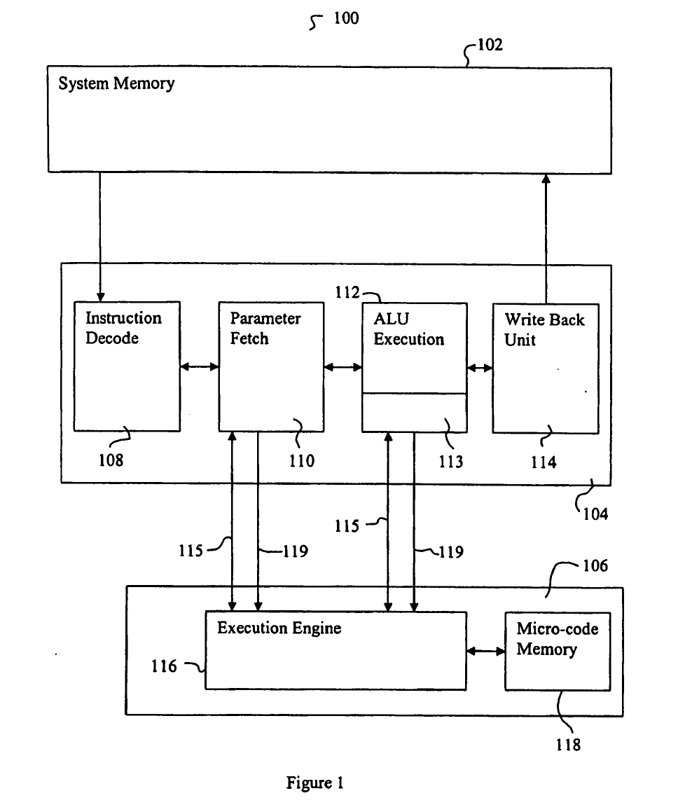

FIG. 1 shows a central processing unit having a micro-code engine 100 cludes a system memory 102, a central processing unit (“CPU”) execution unit 104 coupled with the system memory 102, and a micro-code engine 106 coupled with the CPU execution unit 104. Herein, the phrase “coupled with” is defined to mean directly connected to or indirectly connected through one or more intermediate components. Such intermediate components may include both hardware and software based components.

The system memory 102 may be any type of memory capable of storing a program/object code instruction and micro-code, and may include intermediate memories such as cache memories. In one embodiment, the CPU execution unit 104 is a hardware unit, or other fixed execution unit, hardwired to execute various operations and issue various commands to the micro-code engine 106. Typically, the hardware unit contains a plurality of discrete logic elements, wherein each of the plurality of discrete logic elements is interconnected with at least one other of the plurality of discrete logic elements to perform a plurality of functions.

The micro-code engine 106 is a device such as a processor, or other programmable execution unit, capable of running micro-code programs to execute various operations within a higher-level processor, i.e. the micro-code engine 106 implements one or more of the higher level object code instructions available for use to a programmer. A micro-code engine 106, as will be described in more detail below, may be utilized in addition to or in place of hardwired circuits and logic for implementing the functionality of a higher level central processing unit.

The system memory 102, CPU execution unit 104, and micro-code engine 106 may all be located on a single integrated circuit or may be discrete components. In one embodiment, at least the CPU execution unit 104 and the micro-code engine 106 are located on the same integrated circuit.

In other embodiments, the CPU execution unit 104, and the micro-code engine 106 may all be located on a field programmable gate array or on discrete field programmable gate arrays. In alternative embodiments, it is possible for a central processing unit to have multiple system memory units 102, CPU execution units 104, or micro coded engines 106 which may all be located on a single device such as an integrated circuit or a field programmable gate array, or the units may be located on discrete components.

In general, the system memory 102 stores program/object code instructions for the CPU execution unit 104 and, in one embodiment, micro-code for the micro-code engine 106. The CPU execution unit 104, acting as a controller, reads and decodes each instruction in the system memory 102. Based on each decoded instruction, the CPU execution unit 104 determines the functions needed to perform the instruction from a plurality of hardwired functions available to be performed by the arithmetic logic unit (“ALU”) execution unit 112 of the CPU execution unit 112 and a plurality of micro-code functions available to be performed by the micro-code engine 106. Typically, the CPU execution unit 104 generates a signal comprising at least one parameter to indicate what, if any, functions in the ALU execution unit 112 and the micro-code engine 106 are needed to be executed to implement the instruction. In response to receiving the signal, the ALU execution unit 112 and the micro-code engine 106 perform their operations, and typically, return a result to the CPU execution unit 104. The result may comprise an action, a second signal, and/or a result parameter. In response to receiving the result, the CPU execution unit 104 may store the result in system memory 102 or determine a second function from the first and second plurality of functions for at least one of the AL U execution unit 112 and the micro-code engine 106 to perform.

Micro-code is the lowest-level programming that may directly control a microprocessor. Typically, micro-code is not program-addressable but is capable of being modified e.g. existing micro-code may be modified to correct defects or enhance performance, or additional micro-code programs can be added to the micro-code engine 106, such as to add new instructions types available for operations. In one embodiment, micro-code programs are added to the micro-code engine 106 by downloading the micro-code programs through the CPU execution unit 104. In alternative embodiments, micro-code programs are added to the micro-code engine 106 by downloading the micro-code programs to the micro-code engine 106 directly.

Typically, the micro-code engine 106 is able to execute micro-code programs that may include a plurality of micro-instructions or may implement one or more functions/instructions of the micro-code engine 106. In one embodiment, micro-code programs are used to emulate operations which would be typically hardwired in a processor. Processors with hardwired operations normally execute operations more quickly than a processor using a micro-code engine, but at the cost of system flexibility. Once a processor is hardwired, using devices such as logic gates or transistors to perform operations, the processor cannot execute new instruction types without redesigning the hardwired operations of the processor. Such redesigning is costly, time consuming and may introduce design errors into the overall processor design.

Micro-code engines 106 allow for reduced silicon area in comparison to hardwired operations in a processor and provide flexibility by allowing a user to write additional micro-code programs to execute new instruction types or modify existing micro-code programs to correct defects or enhance performance. For example, if new instruction types are needed for a new algorithm after the initial design of the system, a new micro-code program can simply be written and downloaded to the micro-code engine 106 thereby altering the operation of the processor. Further, if defects or performance issues are discovered in the operation of the processor, the micro-code may be altered or augmented to correct the problem or enhance performance.

Micro-code engines 106 also alleviate the need for a separate digital signal processor (“DSP”). In order to accelerate image processing, some systems use a separate DSP with a completely discrete CPU having built-in image processing functions. Accelerating image processing using a separate DSP comes at the cost of increased silicon requirements, and a lack of communication between the control CPU and the separate DSP. Micro-code engines, as disclosed herein, may be used in place of, or to augment, the DSP.

In one embodiment of a CPU having a micro-code engine, the CPU execution unit 104 is electrically coupled with the system memory 102 such that the CPU execution unit 104 can read instructions stored in the system memory 102 or write data to the system memory 102. The CPU execution unit 104 generally includes an instruction decoder 108, a parameter fetching unit 110, an Arithmetic Logic Unit (“ALU”) execution unit 112, and a write back unit 114. Preferably, the instruction decoder 108, parameter fetching unit 110, ALU execution unit 112, and write back unit 114 are electrically coupled with each other so that the parameters of each instruction can easily be passed between the different units of the CPU execution unit 104.

The micro-code engine 106 is also electrically coupled 115 with the CPU execution unit 104 such that the CPU execution unit 104 can treat the micro- code engine 106 as a hardware assisted instruction. Typically, the CPU execution unit 104 and the micro-code engine 106 are arranged in a parallel fashion where both are capable of operating substantially concurrently while executing the same or different functions. In alternative embodiments, the CPU execution unit 104 and the micro-code engine 106 may also be arranged in a serial or pipeline fashion or any other arrangement known in the art. Through the electrical coupling 115, the CPU execution unit 104 controls which instructions the micro-code engine 106 will execute, and how and when the micro-code engine 106 will execute each instruction. Specifically, the CPU execution unit 104 typically controls what micro-code and instruction parameters the micro-code engine 106 receives and what data the micro-code engine 106 may pass to the CPU execution unit 104 or the system memory 102.

Typically, the micro-code engine 106 includes a micro-code execution unit 116 and a micro-code memory 118. The micro-code execution unit 116 and the micro-code memory 118 are typically electrically coupled with each other so that the micro-code execution unit 116 can read instruction parameters or micro-code stored in the micro-code memory 118, or write data to the micro-code memory 118.

During operation, the CPU execution unit 104 reads a program/object code instruction stored in the system memory 102. Typically, the instruction decoder 108 within the CPU execution unit 104 acts as a controller to examine the instruction set and determine what operations are required to execute the various instructions contained therein. Depending on the necessary operations for a given instruction, the CPU execution unit 104 may use the hardwired operations 113 of the CPU execution unit 104 to execute the instruction, the CPU execution unit 104 may actuate the micro-code engine 106 to execute the instruction, or the CPU execution unit 104 may use the hardwired operations 113 of the CPU execution unit 104 to execute a portion of the instruction while the micro-code engine 106 executes another portion of the instruction.

If the CPU execution unit 104 uses the hardwired operations 113 of the CPU execution unit 104 to execute the instruction, the parameter fetching unit 110 typically passes the instruction parameters to the ALU execution unit 112. The ALU execution unit 104 performs the necessary operations under the direction of the hardwired logic and the write back unit 114 records the result of the instruction in the system memory 102, a register, or other storage.

If the CPU execution unit 104 actuates the micro-code engine 106 to execute the instruction, the parameter fetching unit 110 typically passes the instruction parameters, any necessary micro-code if not already loaded, and any other commands to the micro-code engine 106. The micro-code execution unit 116, acting as a micro-code controller, receives the information from the CPU execution unit 104 and reads any additional information that may be stored in the micro-code memory 118. The micro-code execution unit 116 executes the operation, i.e. the micro-code program which implements the instruction, and records the result of the instruction in the micro-code memory 118 or otherwise passes the result to the CPU execution unit 104. If necessary, the write back unit 114 then records the result of the instruction in the system memory 102, a register, or other storage. In one embodiment, while the micro-code engine 106 is processing the operation, the CPU execution unit 104 is free to perform other operations. In alternate embodiments, the CPU execution unit 104 waits for the micro-code engine 106 to complete the operation before performing other actions.

If the CPU execution unit 104 uses the hardwired operations 113 of the CPU execution unit 104 to execute a portion of the instruction while the micro-code engine 106 executes another portion of the instruction, the parameter fetching unit 110 passes the instruction parameters to the ALU execution unit 112 and the micro-code execution unit 116. The ALU execution unit 112 and the micro-code execution unit 116 execute their operations in parallel or in series depending on the algorithm, and the result of the instruction is written to the system memory 102, a register, or other storage. In one embodiment, the ALU execution unit 112 may factor the output of the micro-code engine 106 into the final result.

In another embodiment, the CPU execution unit 104 and the micro-code engine 106 are able to perform operations on either the same or different data, at the same time or at different times. In order to ensure the CPU execution unit 104 and micro-code engine 106 perform operations in the proper order, hand shake signals 119 may be implemented between the CPU execution unit 104 and the micro-code engine 106. Hand shake signals 119 are signals such as WAIT signals or other status indicators passed between at least two units of a processor to ensure that an algorithm is executed in proper order. Through the hand shake signals 119, the CPU execution unit 104 and the micro-code engine 106 are able to pass signals so that the CPU execution unit 104 and the micro-code engine 106 may operate synchronously. While the hand shake signals 119 permit the CPU execution unit 104 and micro-code engine 106 to operate synchronously with respect to each other, these signals 119 may also permit signaling between the CPU execution unit 104 and the micro-code engine 106 so as to allow either CPU execution unit 104, the micro-code engine 106 or both to internally operate synchronously or asynchronously.

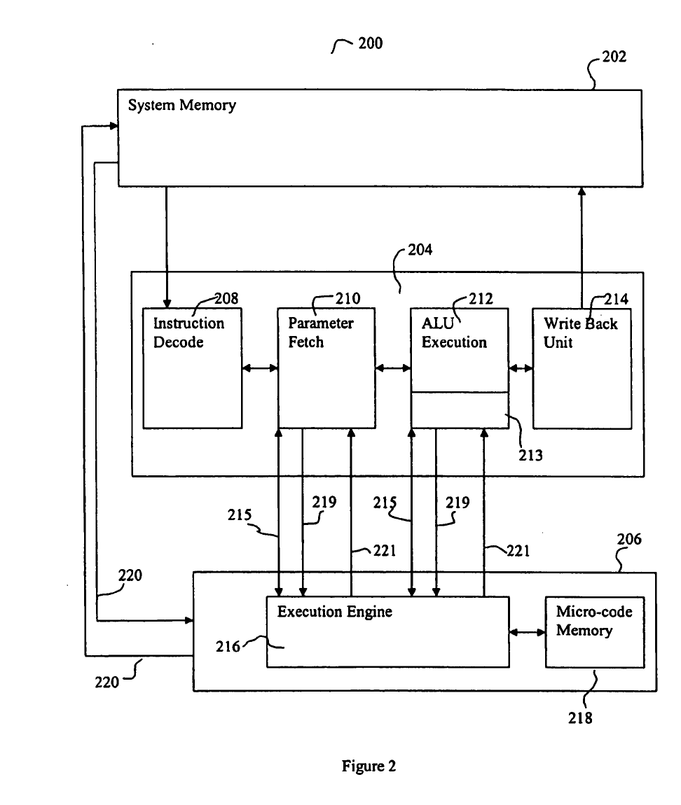

In yet another embodiment, shown in FIG. 2, separate direct memory access (“DMA”) channels 220 between the system memory 202 and the micro-code engine 206, and additional hand shake signals 221 between the CPU execution unit 204 and the micro-code engine 206 are provided. Separate DMA channels 220 allow the system to operate more quickly and efficiently by allowing the micro-code engine 206 to directly read data stored in the system memory 202 instead of the micro-code engine 206 only being able to read data the CPU execution unit 204 has read from the system memory 202.

The additional hand shake signals 221 between the CPU execution unit 204 and the micro-code engine 206 allow the CPU execution unit 204 and the micro-code engine 206 to operate synchronously in more complex executions. The additional hand shake signals allow the micro-code engine 206 and the CPU execution unit 204 to communicate with each other as compared to other embodiments where only the CPU execution unit 204 issued commands to the micro-code engine 206. The ability for both the CPU execution unit 204 and the micro-code engine 206 to pass hand shake signals allows the CPU execution unit 204 and the micro-code engine 206 to act in a peer-to-peer fashion rather than in a master-slave fashion.

A central processing unit having a micro-code engine according to the disclosed embodiments can be used in devices such as a digital camera to implement and/or accelerate image processing, in addition to or in place of a separate DSP. A micro-code engine allows a digital camera manufacturer to change micro-code programs within the micro-code engine to correct problems, improve functions, implement proprietary image processing algorithms, or add features in reaction to market driven desires for camera functions without the cost of redesigning the camera hardware. Due to the flexibility of a micro-code engine, a digital camera manufacturer can change the micro-code programs, and therefore the digital camera functions, at any time during or after the design and manufacture of the camera, even after the purchase of a camera.

In one embodiment of a digital camera having a central processing unit and micro-code engine as disclosed, the micro-code engine executes one or more micro-programs which implement specific operations for compressing pixel data generated by the camera's image sensor. In another embodiment, the micro-code engine executes one or more micro-programs which implement specific operations for demosaicing the pixel data generated by the camera's image sensor where the image sensor utilizes a color filter array, such as a Bayer pattern color filter array.

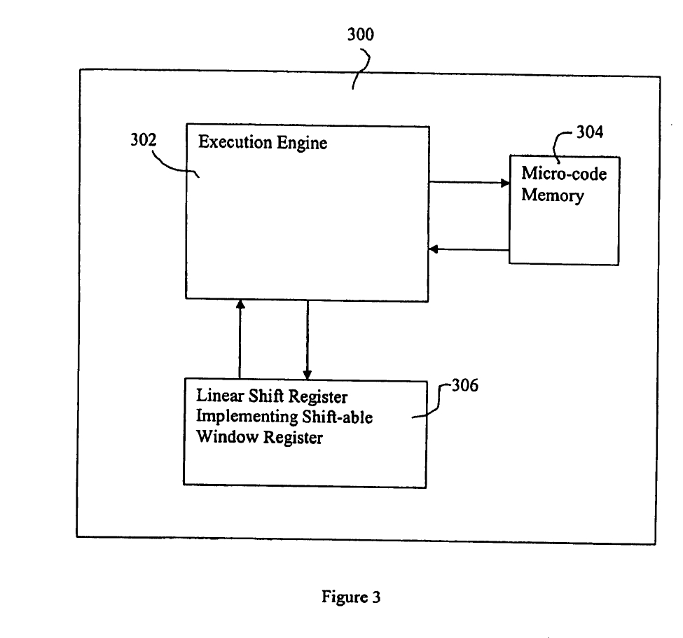

In another embodiment of a central processing unit having a micro-code engine, shown in FIG. 3, a micro-code engine 300 includes a linear shift register to perform a shift-able window operation. A micro-code engine 300 with linear shift registers generally includes a micro-code execution unit 302, a micro-code memory 304, and a linear shift register implementing a shift-able window 306. The micro-code engine 300 is preferably an application specific integrated circuit capable of running micro-code programs, but the micro-code engine 300 could be implemented by any means known in the art. Additionally, the incorporation of the linear shift register 306 with other logic devices could be implemented by any means known in the art.

Typically, the micro-code execution unit 302 is electrically coupled with the micro-code memory 304 such that the micro-code execution unit 302 can both read an instruction or micro-code stored in the micro-code memory 304 and write data to the micro-code memory 304. Preferably, additional micro-code can be added to the micro-code memory 304 at any time as new instruction types become available for operations.

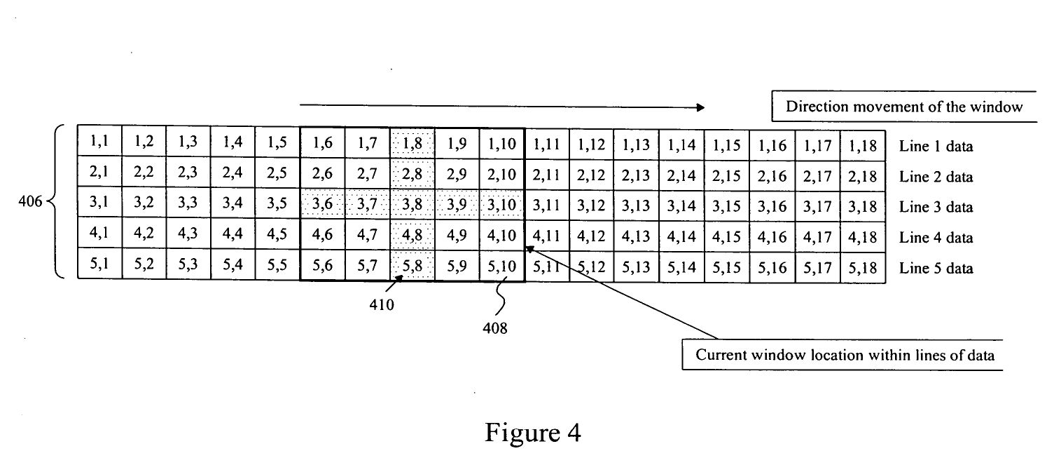

In one embodiment, shown in FIG. 4, a linear shift register 406 implementing a shift-able window 408 operates on a set of data from (1,1) to (5,18). The shift-able window 408 needed for the algorithm of FIG. 4 is in the shape of a cross, but due to the flexibility of micro-code programs, the linear shift register 406 implementing the shift-able window 408 may be square of size n×n, rectangular of size n×m, or an irregular size and shape, defining which data elements may be simultaneously accessed at any given shift event. The shape of the shift-able window 408 is dependent on the parameters of an algorithm with the only size and shape requirement being that the shift-able window 408 contain all the necessary operands to execute the algorithm. In the example shown in FIG. 4, an operand 410 needed to execute an algorithm is shown in gray.

As shown in FIG. 4, data is continuously fed into the linear shift registers 406. By running a micro-code program within the micro-code execution unit 302 (FIG. 3) that utilizes the shift-able window 408, the micro-code execution unit 302 (FIG. 3) can continuously execute an algorithm on the data stored within the set of linear registers 406.

The shift-able window 408 provides the ability to continuously execute an algorithm on the continuous data being serially input into the linear shift registers 406 by shifting data from a new section of the linear shift registers 406 into the shift-able window 408 after the micro-code execution unit 302 (FIG. 3) completes an operation. Typically, each register within the linear shift registers 406 can be addressed as an operand 410 in the shift-able window 408. Shifting the new data into the shift-able window 408 from a new section of the linear shift registers 406 changes the operands 410 such that data for the new and subsequent targeted location within the linear shift register 406 are in the correct relative location. Therefore, the data values for the next operation by the micro-code execution unit 302 (FIG. 3) are available without re-fetching the data or re-aligning the data by the CPU execution engine or the micro-code engine 300 (FIG. 3).

Simply shifting only the new data into the shift-able window 408, without re-aligning the old data, accelerates image processing by increasing the efficiency of the micro-code engine 300 (FIG. 3). Shifting new data into the shift-able window 408 avoids repetitive operations typically associated with processor functions such as extra fetching operations, load operations, or store operations. The CPU or micro-code engine 300 (FIG. 3) will use the saved time and cycle to execute the algorithm, increasing the overall efficiency.

Previously, to accelerate image processing in digital cameras, designers have used a shift-able window made through software or a shift-able window made through hardwired operations. The shift-able window made through software provides flexibility, but lacks the speed of hardwired operations. The hardwired operations execution image processing functions quickly, but at the cost of flexibility due to the fact the size-and shape of the shift-able window are fixed. Increasing the efficiency of a processor using a linear shift register implementing a shift-able window compensates for the tradeoff between speed and flexibility, thereby providing a window operation that can both quickly execute operations for an algorithm and is flexible to accommodate future changes, e.g. new instructions or algorithms that require a new window size or shape.

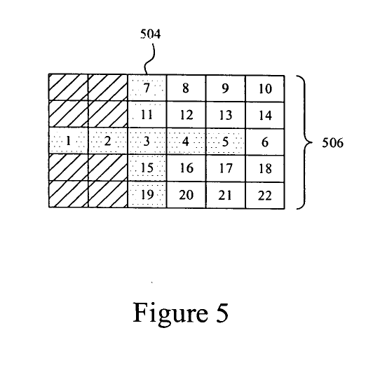

FIG. 5 shows the mapping of the linear shift register 506 implementing the shift-able window 504 of FIG. 4. The number within each element of the shift-able window 504 represents the sequence of that element within the linear shift register 506. When data shifts through the linear shift register 506, the data in element I shifts into element 2, while the data in element 2 shifts into element 3. This process continues sequentially throughout the linear shift register.

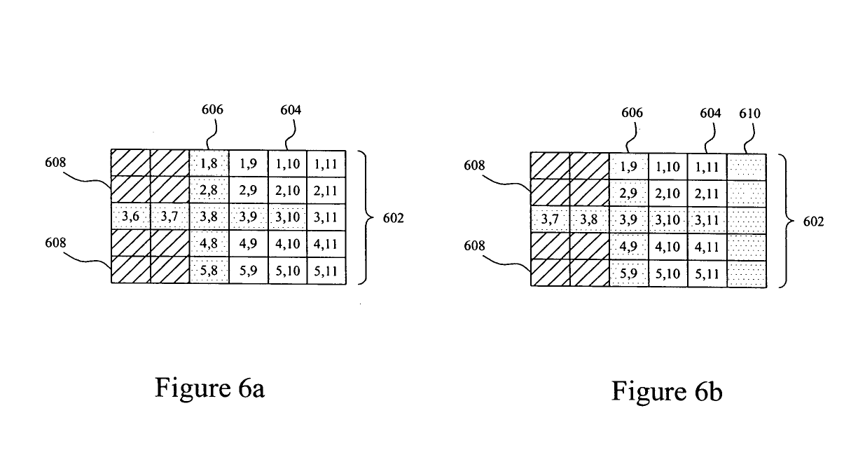

FIGS. 6a and 6b show one embodiment of a shift-able window 604, using the mapping of FIG. 5, before and after a shift operation. A shift operation shifts new data into the operands 606 of the shift-able window 604. In the embodiment shown in FIGS. 6a and 6b, data is shifting from right to left through the shift-able window 604, but the shift-able window 604 may be designed so that data may be shifted from any direction into the operands 606 of the shift-able window 604. As data is shifted from right to left, the areas of the shift-able window 604 shown in black 608 and in gray 610 represent data values that are no longer needed for image processing operations. Thus, even though the data values exist within the linear shift register 602, the data values can be considered non-existent. The registers of column 610 represent the next set of registers that new data could be stored in. The shift-able window 604 may be implemented through a serial set of registers, a circular set of registers, or any other register design known in the art.

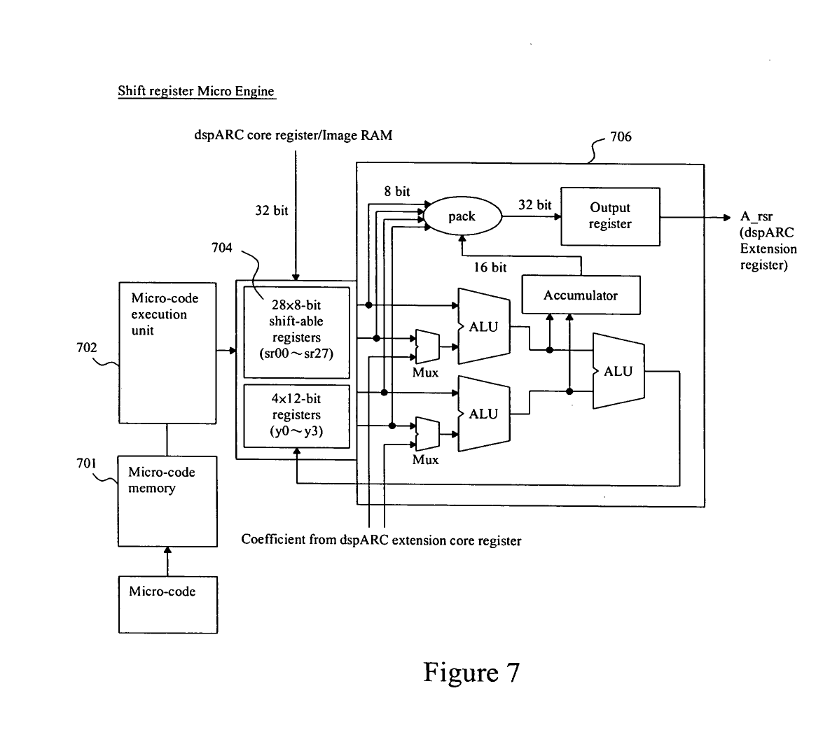

In another embodiment, shown in FIG. 7, a shift register micro-engine 700 generally includes a micro-code memory 701, a micro-code execution unit 702, a series of shift-able registers 704, and a series of logic devices 706. In one embodiment, the logic devices 706 are electrically coupled with the shift-able registers 704 such that the logic devices 706 perform a calculation on the operands contained in the current shift-able window of the micro-code execution unit 702. Additionally, the micro-code memory 701, and micro-code execution unit '702 are electrically coupled with the shiftable registers 704 such that by reading the micro-code programs stored within the micro-code memory 701, the micro-code execution unit 702 knows the direction of the operation on the linear shift register, and the direction of data flow.

In general, data, such as pixel data, is constantly serially input into the series of shift-able registers 704 from a device such as a CCD of a digital camera or by any intermediate means such as Direct Memory Access (“DMA”) or by loading through the CPU core. As data shifts through the series of shift-able registers 704., the logic devices 706 calculate a result based on the current operands present in the shift-able window. This operation can be a filter operation or an interpretation based on data currently within the window, or any other logically, algorithmically useful operation. After the algorithm is complete on the current operands, a shift operation shifts the data linearly and effectively moves the shift-able window forward by one pixel. After the shift operation, the shift-able window is targeting a new pixel, even though half the surrounding pixels for the algorithm will be retained and located in their correct relative location. Only new data that is needed but not within the shift-able window is shifted into the shift-able window. After the shift operation, the logic devices 706 automatically calculate a result for the new set of operands and output a result. This process is continually repeated as data is serially input through the series of shift-able registers 604.

In another embodiment, direct memory access channels may be added between the linear shift registers and the micro-code engine to further accelerate image processing operations. In yet another embodiment to enhance performance, additional instructions may be added for the shift-able window to perform more than one shift operation per instruction and/or cycle.

In one embodiment of a digital camera having a central processing unit and a micro-code engine that includes a linear shift register to perform a shift-able window operation, the shift-able window is used to execute specific operations on pixel data such as a filter operation or an interpretation operation. In other embodiments, the shift-able window may be used to perform compression algorithms, demosaicing algorithms, or any other type of algorithm using pixel data as an operand.

For example, in an embodiment using a shift-able window to employ a demosaicing algorithm, the shift-able window surrounds a targeted pixel and the pixels nearby the targeted pixel that are needed to create a three-color per pixel image from a one-color per pixel image. When a digital camera uses a color filter array (“CFA”) such as a Bayer CFA, red, green, and blue pixels are arranged in a predetermined pattern so that each color pixel is adjacent to the two other color pixels. Demosaicing algorithms are used to create a three-color per pixel images from one-color per pixel images using processes such as bilinear interpolation. In this process, a one-color targeted pixel and its surrounding one-color pixels are used to create a single three-color pixel. A shift-able window accelerates the demosaicing algorithm by quickly shifting new pixel data into the shift-able window after each bilinear interpolation is complete on a targeted pixel and its nearby pixels.

It is therefore intended that the foregoing detailed description be regarded as illustrative rather than limiting, and that it be understood that it is the following claims, including all equivalents, that are intended to define the spirit and scope of this invention.

1. A central processing unit comprising
a fixed execution unit operative to perform a first plurality of functions;
a programmable execution unit operative to perform a second plurality of functions; and
a controller, coupled with said fixed execution unit and said programmable execution unit, said controller being operative to receive an instruction from a memory coupled with said controller, determine a first function of at least one of said first and second plurality of functions to be performed based on said instruction and generate a signal to at least one of said fixed execution unit and said programmable execution unit to perform said first function; and
wherein said fixed execution unit further comprises:
a first input coupled with said controller and operative to receive said signal;
a plurality of discrete logic elements coupled with said first input, each of said plurality of discrete logic elements being interconnected with at least another of said plurality of discrete logic elements and further coupled with said first input to implement at least one of said first plurality of functions in response to said signal, said at least one of said first plurality of functions being determined based on said signal to cause said fixed executed unit to perform said first function; and
wherein said programmable execution unit further comprises:
a second input coupled with said controller and operative to receive said signal;
a micro-code memory operative to store a plurality of micro-programs, each of said plurality of micro-programs operative to implement at least one of said second plurality of functions;
a micro-code execution unit coupled with said micro-code memory and capable of selectively executing each of said plurality of micro-programs;
a micro-code controller coupled with said second input and said micro-code execution unit and operative to cause said micro-code execution unit to execute at least one of said plurality of micro-code programs in response to said signal to cause said programmable execution unit to perform said first function.

2. The central processing unit of claim 1, wherein said fixed execution unit further comprises:
a first output coupled with said plurality of discrete logic elements and said controller and operative to transmit a first result generated by said plurality of discrete logic elements to said controller in response to said signal.

3. The central processing unit of claim 2, wherein:
said first result comprises an action, a signal parameter, and a result parameter.

4. The central processing unit of claim 2, wherein said programmable execution unit further comprises:
a second output coupled with said micro-code controller and said controller and operative to transmit a second result generated by said at least one of said plurality of micro-code programs to said controller in response to said signal.

5. The central processing unit of claim 4, wherein:
said second result comprises an action, a signal parameter, and a result parameter.

6. The central processing unit of claim 4, wherein:
said controller is further operative to receive at least one of said first and second result from said one of said fixed logic execution unit and said micro-code execution unit, and store said received at least one of said first and second result in said memory.

7. The central processing unit of claim 4, wherein:
said controller is further operative to receive at least one of said first and second result from said one of said fixed logic execution unit and said micro-code execution unit, determine a second function of at least one of said first and second plurality of function to be performed based on at least one of said first and second result, and generate a new value for said signal to at least one of said fixed execution unit and said programmable execution unit to perform said second function.

8. The central processing unit of Clam 1, wherein:
said signal comprises at least one parameter.

9. The central processing unit of claim 1, wherein:
said micro-code execution unit is further coupled with said fixed logic execution unit.

10. The central processing unit of claim 1, wherein:
said fixed execution unit and said programmable execution unit operate in synchronization.

11. The central processing unit of claim 10, wherein:
said fixed execution unit and said programmable execution unit operate in a parallel fashion.

12. The central processing unit of claim 10, wherein:
said fixed execution unit and said programmable execution unit operate in a serial fashion.

13. The central processing unit of claim 10, wherein:
said fixed execution unit and said programmable execution unit operate in a pipeline fashion.

14. The central processing unit of claim 1, further comprising:
a direct memory access channel coupled between said programmable execution unit and said memory.

15. A method for performing an instruction within a central processing unit comprising:
receiving an instruction from a memory coupled with a controller;
determining a first function of at least one of a first plurality of functions capable of being performed by a fixed execution unit and a second plurality of functions capable of being performed by a programmable execution unit;
generating a signal to at least one of said fixed execution unit and said programmable execution unit to perform said first function;
determining in said fixed execution unit which, if any, of said first plurality of functions to execute in response to said signal;
executing at least one of said first plurality of functions by a plurality of discrete logic elements to generate a first result in response to determining said fixed execution engine should execute at least one of said first plurality of functions;
determining in said programmable execution unit which, if any, of said second plurality of functions to execute in response to said signal; and
executing at least one micro-code program to implement at least one of said second plurality of functions to generate a second result in response to determining said programmable execution engine should execute at least one of said second plurality of functions.

16. The method of claim 15, further comprising:
transmitting said first result to said controller in response to said fixed execution unit generating said first result;
transmitting said second result to said controller in response to said programmable execution unit generating said second result; and
receiving at least one of said first and second result in said controller.

17. The method of claim 16, further comprising:
storing said received at least one of said first and second result in said memory.

18. The method of claim 16, further comprising:
determining a second function of at least one of said first and second plurality of functions to be performed based on at least one of said first and second result; and
generating a new signal to at least one of said fixed execution unit and said programmable execution unit to perform said second function.

19. The method of claim 15, further comprising:
passing at least one handshake signal between said fixed execution unit and said programmable execution unit such that said fixed execution unit and said programmable execution unit may operate in synchronization.

20. The method of claim 15, wherein the step of executing at least one micro-code program to implement at least one of said second plurality of functions to generate a second result in response to determining said programmable execution engine should execute at least one of said second plurality of functions:
passing a micro-code program to a micro-code execution unit to execute at least one of said second plurality of functions; and
running said micro-code program to generate said second result.

21. The method of claim 20, further comprising:
storing said second result in a micro-code memory.

22. The method of claim 19, further comprising:
downloading at least one new micro-code program for said micro-code execution unit.
